(19) United States
(12) Patent Application Publication
(10) Pub. No.: US 2013/0033200 A1
(43) Pub. Date: Feb. 7, 2013

(54) SPORT CHRISTMAS KIT

(71) Applicant: RONALD BACHORSKI, PITTSBURG, PA (US)

(72) Inventor: RONALD BACHORSKI, PITTSBURG, PA (US)

(21) Appl. No.: 13/197,771

(22) Filed: Aug. 4, 2011

(51) Int. Cl. H05B 37/02; F21S 4/00

(52) U.S. Cl. 315/313; 362/249.19; 362/249.06

(57) ABSTRACT

A sport Christmas kit includes an artificial Christmas tree having a trunk segment with bristled branches depending generally downwardly and radiating in different directions about the circumference of the trunk segment. A tree stand retains the trunk segment of the artificial Christmas tree in an upright position on a support surface. A sport helmet is put on the top of the tree. A plurality of lights representing a specific color and specific sport team is adorned about the bristle branches of the artificial Christmas tree. A plurality of ornaments, J-shape candies representing the specific sport are hung on the bristle branches of the artificial Christmas tree, whereby a sport fan can indicate and display their favorite sport team therefrom. The lights are flashed in 1-3 seconds programmable delay.

### CROSS-REFERENCE TO RELATED APPLICATION

This application claims the benefit of Provisional Patent Application No. 61/370,201, filed on Aug. 3, 2010, in the United States Patent & Trademark Office, the disclosure of which is incorporated herein by reference.

### BACKGROUND OF THE INVENTION

1. Field of the Invention

The present invention relates to a sport Christmas tree, and more particularly, a sport Christmas kit. The present invention offers a sport fan a unique new way to show team loyalty. An artificial Christmas tree decorated with lights in a specific team's colors will allow the sport fan to prominently display pride for their favorite team. Ornaments with team logos and mascot pictures are added to complete the theme. The artificial Christmas tree is decorated to accommodate sport fans of professional, college, and high school teams. Sports enthusiasts will enjoy the entertainment the sports Christmas kit provides.

2. Description of the Prior Art

Sports fans are always looking for new ways to show their loyalty for their favorite team. Many fans decorate their homes with team flags, posters, and more. During Christmas, much of a home's décor is transformed in order to display holiday decorations. A holiday decoration that incorporates one's favorite team is needed.

Numerous innovations for decorative Christmas trees have been provided in the prior art that will be described. Even though these innovations may be suitable for the specific individual purposes to which they address, however, they differ from the present invention.

A FIRST EXAMPLE, U.S. Pat. No. 5,455,750, issued on Oct. 3, 1995, to Davis et al. teach an artificial holiday tree arrangement which incorporates different elements associated with the Christmas season. The arrangement is comprised of an artificial Christmas tree, which incorporates a scent producing element therein, as well as an illuminated tree-top ornament, all electrically connected to an electric current producing means. Optionally, the arrangement can also incorporate a sound producing means in the tree trunk body or the tree support, to supply holiday music. All the elements of the holiday tree arrangement are connected to and controlled by a control box attached thereto.

A SECOND EXAMPLE, U.S. Pat. No. 6,017,142, issued on Jan. 25, 2000, to Harris Jr. teaches a decorative fiber optic tree formed of a plurality of light conducting optical fibers, each having a first end and a second end. The fiber optic tree includes a base unit having an interior chamber to house a light source. The light source is arranged to produce light that is directed through an opening on an upper surface of the base unit. An elongated and perforated center tube may be included having a top end and a bottom end, and is substantially vertically oriented. The center tube, which is removeably mounted on the base unit, is positioned at least in part over the opening in the upper surface of the base. The optical fibers are disposed partially within the center tube with the first end of each fiber located near the bottom end of the center tube and suitably positioned to enable light from the light source passing through the opening to be coupled into each respective optical fiber. The optical fibers extend partially up the interior of the center tube, with each passing through a respective perforation and extend radially outwardly from the center tube. The light coupled into the first end of each optical fiber is transmitted through the optical fibers to the second where light is emitted to produce a decorative effect.

A THIRD EXAMPLE, U.S. Patent Office Publication No. 2007/0089771, published on Apr. 26, 2007, to Jerry teaches an extensible device for use such as an umbrella engaging mechanism or, alternately, a decorative supported tree. An elongated and lengthwise shaft includes an outer elongated tubular portion and an inner translatable portion. A repositionable clamp device is supported at an upper end of the device, such as for releasably securing an umbrella stem. A rotatable foot support is arranged at a lower end and facilitates driving the shaft into a ground location. In one variant, a rubber dampening insert is secured to a hollowed end of the outer tubular portion and receives a cord extending therethrough and which connects at an interior end to a translatable and noise generating anchor supported upon the end of the inner translatable portion. In another variant, the extensible device functions as a base support for a decorative tree, a plurality of elongated ribs being outwardly extensibly mounted to the outer tubular member, at least at its upper end, and each further including a faux pine branch design.

A FOURTH EXAMPLE, U.S. Patent Office Publication No. 2007/0242455, published on Oct. 18, 2007, to Fair et al. teaches an electrically powered decorative assembly for interior or exterior display. The decorative assembly includes a main electrical string and one or more electrically wired light emitting ornaments electrically and detachably connected to the main string. The decorative assembly may further include one or more light emitting sources electrically connected to the main string. The decorative assembly may be displayed in celebration of religious holidays and secular occasions.

A FIFTH EXAMPLE, U.S. Patent Office Publication No. 2008/0291662, published on Nov. 27, 2008, to Barbieri teaches a lighting system that includes a plurality of circular or disk-shaped lighting rings suitable for installation on a Christmas tree. The lighting rings include lights affixed to a webbing or net, and slits and trunk apertures to facilitate their placement around the Christmas tree trunk. For connection to an electrical power source, the lighting rings include electrical connectors including female electrical and male electrical connectors.

A SIXTH EXAMPLE, U.S. Patent Office Publication No. 2008/0295372, published on Dec. 4, 2008, to Aldineh et al. teach a decorative assembly that includes a first and second multilayered portions. The first layer of each portion is comprised of a releasably adherable material for adhering each portion to a panel. The second and third layers of each portion are comprised of decorative material and the third layer is not co-extensive with the second layer. The first portion is removably adhered to a second panel. The first and second portions of the decorative assembly form a composite image having a three-dimensional appearance when the panels are moved into a closed position.

A SEVENTH EXAMPLE, U.S. Patent Office Publication No. 2008/0298064, published on Dec. 4, 2008, to Cheng teaches a decorative light system including a first frame assembly, a second frame assembly, a thin profile assembly, and a light string system. Both the first frame assembly and the second frame assembly include a frame, which generally is a skeleton, and a sheet that is carried by the frame. The first frame assembly and the second frame assembly are connected to one another by the thin profile assembly, which can include at least one hinge. The thin profile assembly enables the decorative light system to collapse to a thin profile. The light string system is in communication with the second frame assembly, and the light string system includes wiring, a plurality of bulb assemblies. Each bulb assembly includes a socket system, and a light source to illuminate the light string system.

AN EIGHTH EXAMPLE, U.S. Patent Office Publication No. 2009/0236491, published on Sep. 24, 2009, to Rizzo teaches a display mounting for an ornamental object which includes a spring clip having an elongated spring attached at one end and the ornamental object is affixed to the opposite end to be readily attachable to the bill of a cap, Christmas branches etc.

A NINTH EXAMPLE, U.S. Patent Office Publication No. 2010/0053991, published on Mar. 4, 2010, to Boggs teaches an artificial Christmas tree that has a trunk configured in the form of popular or religious inspired figures, which may include a Christian cross, Santa Claus, an angel, Jesus, holiday signage and a reindeer. The artificial tree is provided with a base to support the trunk and with artificial branches and/or materials that simulate the shape of a Christmas tree. The branches and base are removably attached to the trunk to allow for dismantling and storage. The trunk is fabricated from plastic and/or other material that may be translucent to light. A source of light can be disposed inside the trunk to illuminate the trunk. The branches are of different lengths and configurations so that the assembled artificial tree will assume the shape of a Christmas tree as much as possible.

A TENTH EXAMPLE, U.S. Patent Office Publication No. 2011/0141740, Published on Jun. 16, 2011, to Scollan et al. teach a stand for supporting an ornamental object which provides one or more means for appearance customization. In particular, the present invention provides a tree stand with customizable elements flanking the tree-support element(s).

It is apparent now that numerous innovations for decorative Christmas trees have been provided in the prior art that are adequate for various purposes. Furthermore, even though these innovations may be suitable for the specific individual purposes to which they address, accordingly, they would not be suitable for the purposes of the present invention as heretofore described.

### SUMMARY OF THE INVENTION

AN OBJECT of the present invention is to provide a sport Christmas kit that avoids the disadvantages of the prior art.

ANOTHER OBJECT of the present invention is to provide a sport Christmas kit that is simple and inexpensive to manufacture.

STILL ANOTHER OBJECT of the present invention is to provide a sport Christmas kit that is simple to use.

BRIEFLY STATED, STILL YET ANOTHER OBJECT of the present invention is to provide a sport Christmas kit which comprises an artificial Christmas tree having a trunk segment with bristled branches depending generally downwardly and radiating in different directions about the circumference of the trunk segment. A tree stand retains the trunk segment of the artificial Christmas tree in an upright position on a support surface. A plurality of lights representing a specific sport team is adorned about the bristle branches of the artificial Christmas tree. A plurality of ornaments representing the specific sport team are hung on the bristle branches of the artificial Christmas tree, whereby a sport fan can indicate and display their favorite sport team therefrom.

The novel features which are considered characteristic of the present invention are set forth in the appended claims. The invention itself, however, both as to its construction and its method of operation, together with additional objects and advantages thereof, will be best understood from the following description of the specific embodiments when read and understood in connection with the accompanying drawing.

### BRIEF DESCRIPTION OF THE DRAWING

The figures of the drawings are briefly described as follows:

FIG. 1 is a perspective view of the present invention showing an artificial Christmas tree decorated to represent a first type of sport team;

FIG. 2 is a perspective view similar to FIG. 1, showing the artificial Christmas tree decorated to represent a second type of sport team;

FIG. 3 is a perspective view similar to FIG. 2, showing the artificial Christmas tree decorated to represent a third type of sport team;

FIG. 4 is a perspective view of a Sport Christmas kit; and

FIG. 5 is a control box with switch and delay timer/flasher for Sport Christmas kit.

### REFERENCE NUMERALS UTILIZED IN THE DRAWING

110 sport Christmas kit
112 artificial Christmas tree of kit 110
114 trunk segment of artificial Christmas tree 112
116 bristled branches of artificial Christmas tree 112
118 tree stand of kit 110
120 support surface
122 light of kit 110
124 ornament of kit 110
126 J-shaped candies
128 helmet or hat
128A hockey helmet
128B Christmas hat
128C Football helmet
130 a control box
132 a switch
134 a delay timer/flasher

### DETAILED DESCRIPTION OF THE PREFERRED EMBODIMENT

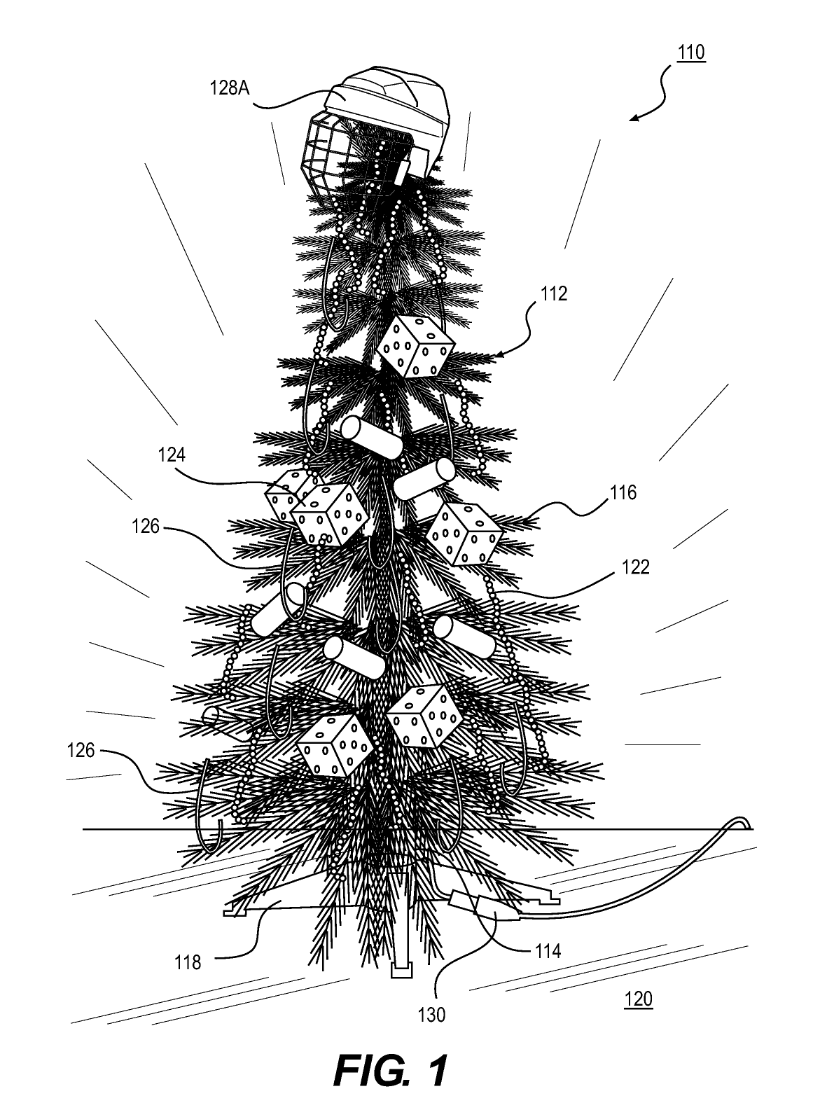

As shown in FIG. 1, the present invention is a sport Christmas kit 110 which comprises an artificial Christmas tree 112 having a trunk segment 114 with bristled branches 116 depending generally downwardly and radiating in different directions about the circumference of the trunk segment 114. A tree stand 118 retains the trunk segment 114 of the artificial Christmas tree 112 in an upright position on a support surface 120, such as a table or a floor. A plurality of lights 122 representing a specific sport team are adorned about the bristle branches 116 of the artificial Christmas tree 112. A plurality of ornaments 124 representing the specific sport team are hung on the bristle branches 116 of the artificial Christmas tree 112, whereby a sport fan can indicate and display their favorite sport team therefrom. A plurality of J-shape candies 126 representing the specific sport team are also hung on the bristle branches 116 of the artificial Christmas tree 112, whereby a sport fan can indicate and display their favorite sport team therefrom. A hockey helmet 128A is also put on the top of the Christmas tree 112.

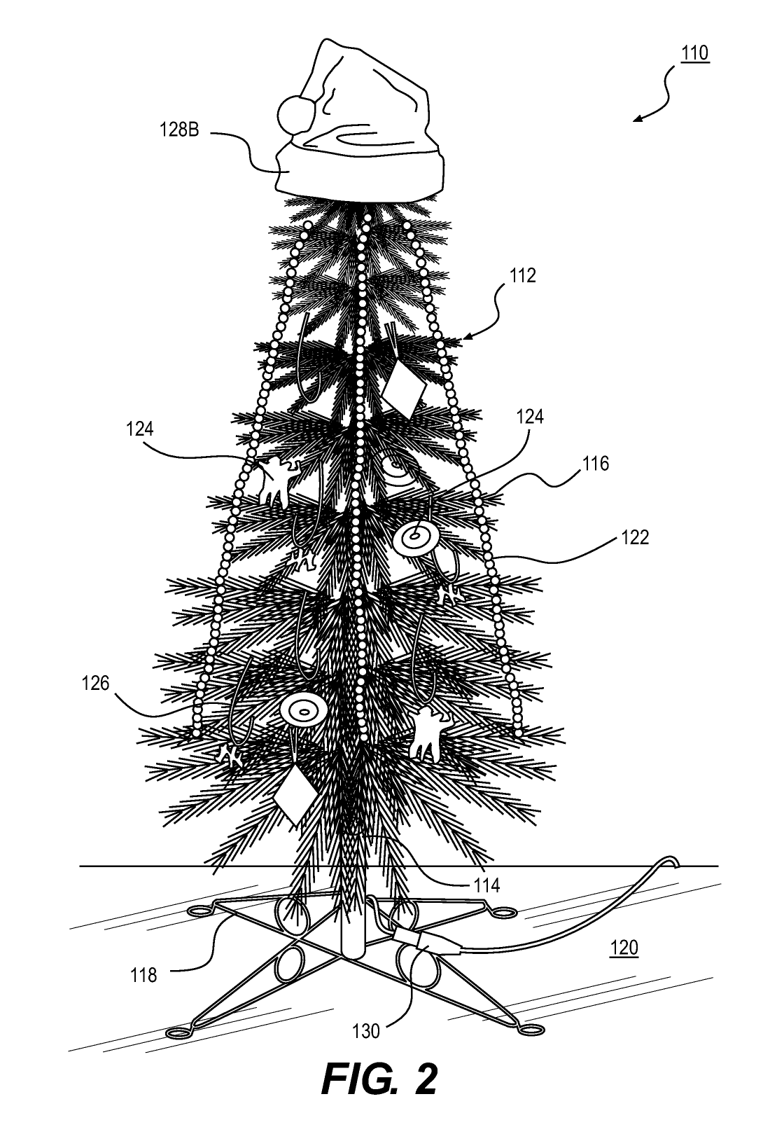

As shown in FIG. 2, the artificial Christmas tree 112 is comprised as a small artificial Christmas tree measuring approximately three feet (3 ft) in height. The optimal height can be selected by the user. The artificial Christmas tree 112 can be comprised in a color to match with the sport team or in various colors to match with the sport team. A Christmas hat 128B is put on the top of the Christmas tree 112. A plurality of J-shape candies 126 representing the specific sport team are also hung on the bristle branches 116 of the artificial Christmas tree 112, whereby a sport fan can indicate and display their favorite sport team therefrom. Each of the lights 122 is comprised as a string light with 75 LED light bulbs. Each of the lights 122 can be comprised in a color to match with the sport team or in various colors to match with the sport team. But, not only are the lights colored but the tree itself is as well. For example: Miami Dolphins Tree—The Tree itself is Aqua colored artificial tree and then Orange lights. Another Example: Washington Redskins Tree—Red Artificial Tree with White Lights and yet another example is Pittsburgh Penguins Tree—A Black artificial Tree with white lights.

Each of the ornaments 124 can be comprised with a sport team logo thereon or with a sport team mascot picture thereon. The sport team can be selected from the group consisting of professional, college and high school sport teams, that include football, soccer, baseball, hockey and the like.

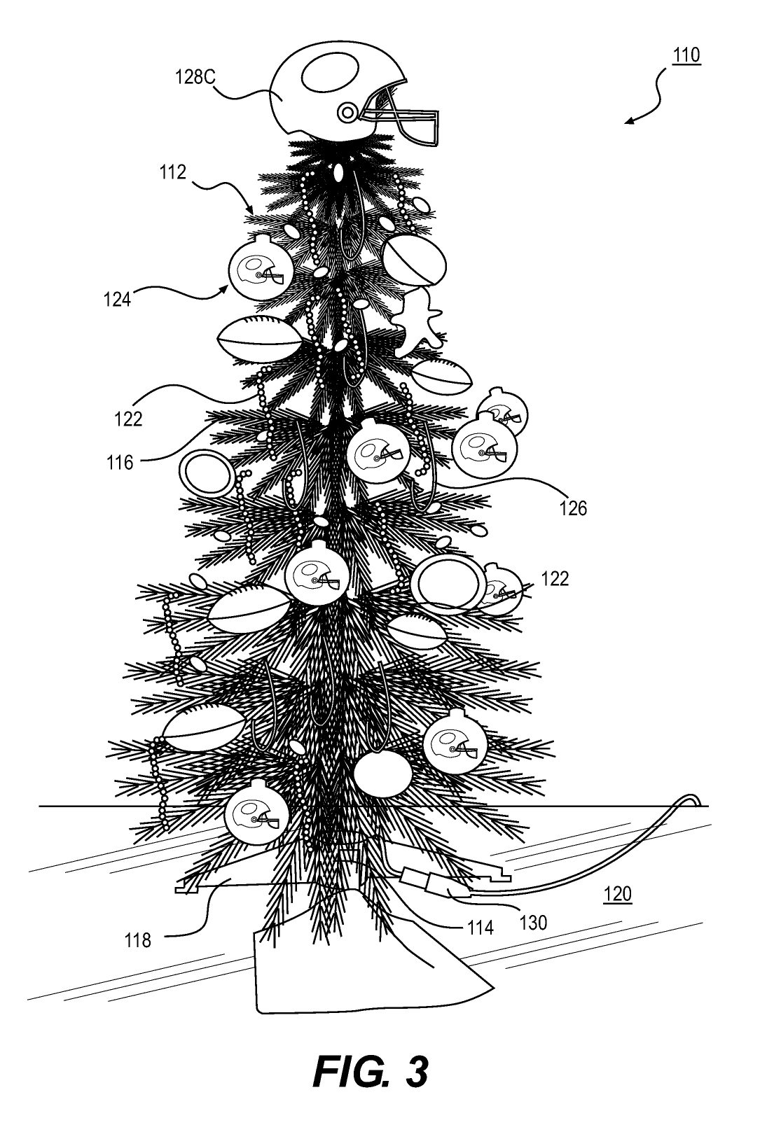

As shown in FIG. 3, the sport Christmas kit 110 allows users to show team pride during the holidays. The present invention includes an artificial Christmas tree 112 being a small artificial Christmas tree measuring approximately three feet (3 ft) in height. A plurality of J-shape candies 126 representing the specific sport team are also hung on the bristle branches 116 of the artificial Christmas tree 112, whereby a sport fan can indicate and display their favorite sport team therefrom. The artificial Christmas tree is adorned with colored lights 122. The color of the lights 122 may be determined by which team is being represented. The artificial Christmas tree 112 may be in a variety of color combinations for a wide variety of sports teams. Team ornaments 124 are also included. A football helmet 128A is put on the top of the Christmas tree 112. The artificial Christmas tree 112 is decorated to represent professional, college, and high school teams. Sports may include football, soccer, baseball, hockey, and the like. The exact specifications may vary.

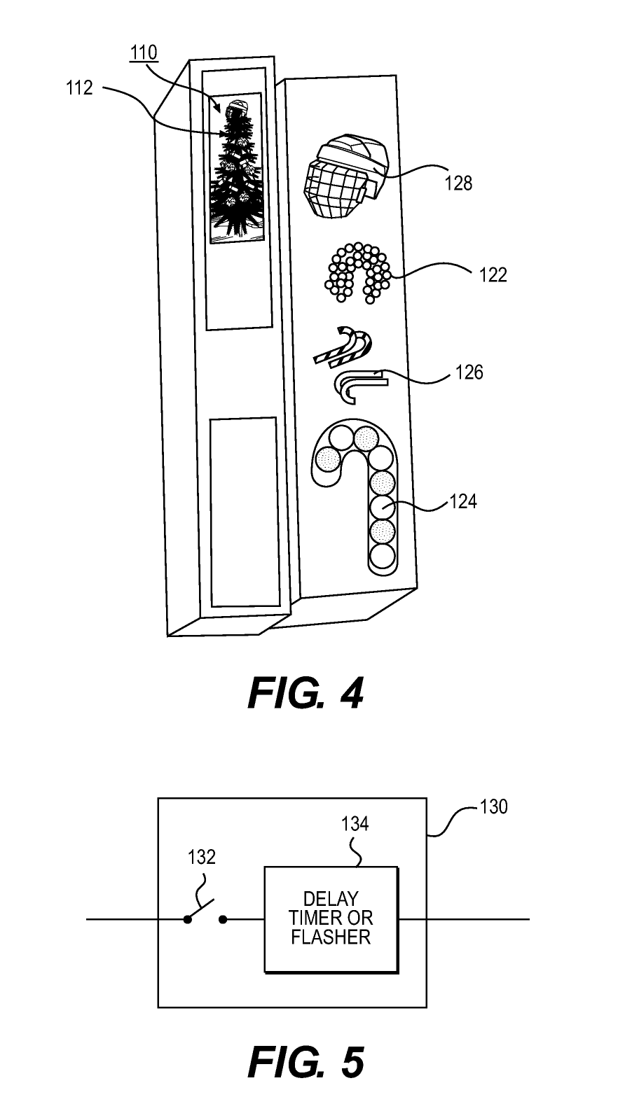

As shown in FIG. 4, a Sport Christmas kit 110 is in a sealed plastic package. The Sport Christmas kit 110 includes an artificial Christmas tree 112, a plurality of lights 122 representing a specific sport team, a plurality of ornaments 124 representing the specific sport team, a plurality of J-shape candies 126 representing the specific sport and a sport helmet 128.

As shown in FIG. 5, a control box 130 includes a switch 132 and a delay timer/flasher 134. The control box 130 is for lighting up the tree 112 in a time sequence ON/OFF with 1 second, 2 seconds or 3 seconds programmable delays.

It will be understood that each of the elements described above, or two or more together, may also find a useful application in other types of constructions differing from the types described above.

While the invention has been illustrated and described as embodiments of a sport Christmas kit, accordingly it is not limited to the details shown, since it will be understood that various omissions, modifications, substitutions and changes in the forms and details of the device illustrated and its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute characteristics of the generic or specific aspects of this invention.

The invention claimed is:

1. A Sport Christmas kit in a sealed plastic package which comprises:
a) an artificial Christmas tree having a trunk segment with bristled branches depending generally downwardly and radiating in different directions about the circumference of the trunk segment, wherein the tree has a first color;
b) a tree stand to retain the trunk segment of the artificial Christmas tree in an upright position on a support surface;
c) a plurality of lights representing a second color and specific sport team adorned about the bristle branches of the artificial Christmas tree;
d) a plurality of J-shape candies representing the specific sport team are also hung on the bristle branches of the artificial Christmas tree, whereby a sport fan can indicate and display a specific favorite sport team therefrom;
e) a team sport helmet is for putting on the top of the Christmas tree; and
f) a plurality of ornaments representing the specific sport team hung on the bristle branches of the artificial Christmas tree, whereby a sport fan can indicate and display the specific favorite sport team therefrom.

2. The sport Christmas kit as recited in claim 1, wherein the artificial Christmas tree is comprised as a small artificial Christmas tree measuring approximately three feet in height.

3. The sport Christmas kit as recited in claim 1, wherein the artificial Christmas tree is comprised in a color to match with the sport team.

4. The sport Christmas kit as recited in claim 1, wherein the artificial Christmas tree is comprised in various colors to match with the sport team.

5. The sport Christmas kit as recited in claim 1, wherein each of the lights is comprised as a string light with 75 LED light bulbs.

6. The sport Christmas kit as recited in claim 1, wherein each of the lights is comprised in a color to match with the sport team.

7. The sport Christmas kit as recited in claim 1, wherein each of the lights is comprised in various colors to match with the sport team.

8. The sport Christmas kit as recited in claim 1, wherein each of the ornaments is comprised with a sport team logo thereon.

9. The sport Christmas kit as recited in claim 1, wherein each of the ornaments is comprised with a sport team mascot picture thereon.

10. The sport Christmas kit as recited in claim 1, wherein the sport team is selected from the group consisting of professional, college and high school sport teams, that include football, soccer, baseball, hockey and the like.

11. The sport Christmas kit as recited in claim 1, further comprising a control box includes a switch and a delay timer/flasher wherein the control box is for lighting up the tree in a time sequence ON/OFF with 1 second, 2 seconds or 3 seconds programmable delays.

12. The sport Christmas kit as recited in claim 1, wherein the first color is different than the second color.
